(19) United States
(12) Patent Application Publication
(10) Pub. No.: US 2012/0182231 A1
(43) Pub. Date: Jul. 19, 2012

(54) Virtual Multi-Touch Control Apparatus and Method Thereof

(75) Inventor: Chun-Huang Lin, HsinChu City (TW)

(73) Assignee: Chip Goal Electronics Corporation, R.O.C.

(21) Appl. No.: 13/178,049

(22) Filed: Jul. 7, 2011

Related U.S. Application Data
(63) Continuation-in-part of application No. 12/930,868, filed on Jan. 19, 2011.

(51) Int. Cl. G06F 3/041

(52) U.S. Cl. 345/173

(57) ABSTRACT

The present invention discloses a virtual multi-touch control apparatus and a method thereof. The virtual multi-touch control apparatus includes a virtual multi-touch control interface for generating a graphic display; one or more remote controller devices transmitting multiple remote control signals, the one or more remote controller devices being controllable by a user to interact with the virtual multi-touch control interface to generate multiple coordinates or an action command, wherein each remote control signal generates an object; a data format converter device converting the coordinate or action command into data with a format compatible to a physical touch control apparatus; and a processor for processing the converted data, wherein multiple object-tracking series corresponding to different objects are established, each object-tracking series including coordinates or an action command of the same object at different timings.

### CROSS REFERENCE

The present invention is a continuation-in-part application of U.S. Ser. No. 12/930,868, filed on Jan. 19, 2011.

### BACKGROUND OF THE INVENTION

1. Field of Invention

The present invention relates to a virtual multi-touch control apparatus and a method thereof, which enables a user to “multi-touch” control the apparatus in a virtual and remote manner; furthermore, in the virtual multi-touch control apparatus, the hardware circuitry (including the processor and circuits following the processor) and associated software are fully compatible with a current touch control apparatus.

2. Description of Related Art

Touch control apparatuses have become widely used in many applications, such as touchpad in a notebook computer, touch screen in an automatic teller machine, touch panel in a PDA or an electronic dictionary, etc. As shown in FIG. 1, a touch control apparatus typically includes a touch interface 10 which receives an external touch input, and a processor 20 which calculates a coordinate of the input. If different coordinates are obtained at different timings, the apparatus can generate displacement and speed information. Presently there are resistance-type and capacitance-type touch control apparatuses. A resistance-type touch control apparatus senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control apparatus includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

The applications of the aforementioned touch control apparatuses are limited; if a user can not directly contact the touch screen for certain reason, or if such touch screen is not available, the touch control functions can not operate. For example, a television screen can not be made a touch screen because of its large size and the associated cost, and usually a user would not sit very close to the television screen to touch it. As another example, if the image of the screen is projected from a projector, there is no touch screen for a user to touch.

### SUMMARY OF THE INVENTION

An objective of the present invention is to provide a virtual multi-touch control apparatus, whose applications are not limited as the prior art touch control apparatuses and it can be used in applications where the prior art touch control apparatuses can not function. When a user can not conveniently touch the touch screen for certain reason, he still can execute the touch control functions. Furthermore, in the virtual touch control apparatus, the hardware circuitry including the processor and circuits following the processor and associated software are fully compatible with a current touch control apparatus. In the following context of the specification, the present invention is referred to as “virtual multi-touch control apparatus”, and the current touch control apparatus which requires physical touch is referred to as “physical touch control apparatus”.

Another objective of the present invention is provide a virtual multi-touch control method.

To achieve the foregoing objectives, in one perspective of the present invention, it provides a virtual multi-touch control apparatus comprising: a virtual multi-touch control interface for generating a graphic display; one or more remote controller devices transmitting multiple remote control signals, the one or more remote controller devices being controllable by a user to interact with the virtual multi-touch control interface to generate multiple coordinates or an action command, wherein each remote control signal generates an object; a data format converter device converting the coordinates or action command into data with a format compatible to a physical touch control apparatus; and a processor for processing the converted data, wherein multiple object-tracking series corresponding to different objects are established, each object-tracking series including coordinates or an action command of the same object at different timings.

In another perspective of the present invention, it provides a virtue multi-touch control method comprising: providing a virtual multi-touch control interface for generating a graphic display; transmitting multiple remote control signals; generating multiple coordinates or an action command by interaction between the multiple remote control signals and the virtual multi-touch control interface, wherein each remote control signal generates an object; converting the coordinates or action command into data with a format compatible to a physical touch control apparatus; and establishing multiple object-tracking series corresponding to different objects, wherein each object-tracking series includes coordinates or an action command of the same object at different timings.

In the virtual multi-touch control apparatus and method, if the interaction between the remote controller device and the virtual multi-touch interface generates a relative coordinate, preferably, the relative coordinate is converted to an absolute coordinate. Further, it is preferable to convert the coordinate according to a ratio between an area of overall coordinate outputs of the remote controller device and a size of the graphic display generated by the virtual multi-touch interface.

In the virtual multi-touch control apparatus and method, different objects can be identified and distinguished from one another according to at least one of following characteristics: size, shape, color, texture, hollow/solid, aspect ratio of the objects, so as to generate the multiple object-tracking series. Or, different objects can be identified and distinguished from one another according to at least one of following characteristics: movement direction, speed, acceleration, and inertia of the above, of the objects.

The objectives, technical details, features, and effects of the present invention will be better understood with regard to the detailed description of the embodiments below, with reference to the drawings.

### BRIEF DESCRIPTION OF THE DRAWINGS

FIG. 1 is a schematic block diagram of a prior art physical touch control apparatus.

FIG. 2 shows an embodiment of the virtual multi-touch control apparatus according to the present invention.

FIG. 3 shows another embodiment of the virtual multi-touch control apparatus according to the present invention.

FIG. 4A and 4B illustrate an example as to how different objects are identified and distinguished from one another to establish different object-tracking series.

FIG. 5A and 5B illustrate another example as to how different objects are identified and distinguished from one another to establish different object-tracking series.

FIG. 6A and 6B illustrate yet another example as to how different objects are identified and distinguished from one another to establish different object-tracking series.

FIG. 7 shows that “touch control regions” and “non-touch-control region” can be provided on a graphic display.

FIG. 8 shows that multiple coordinates or action commands can be generated by one same remote controller device for virtual multi-touch control.

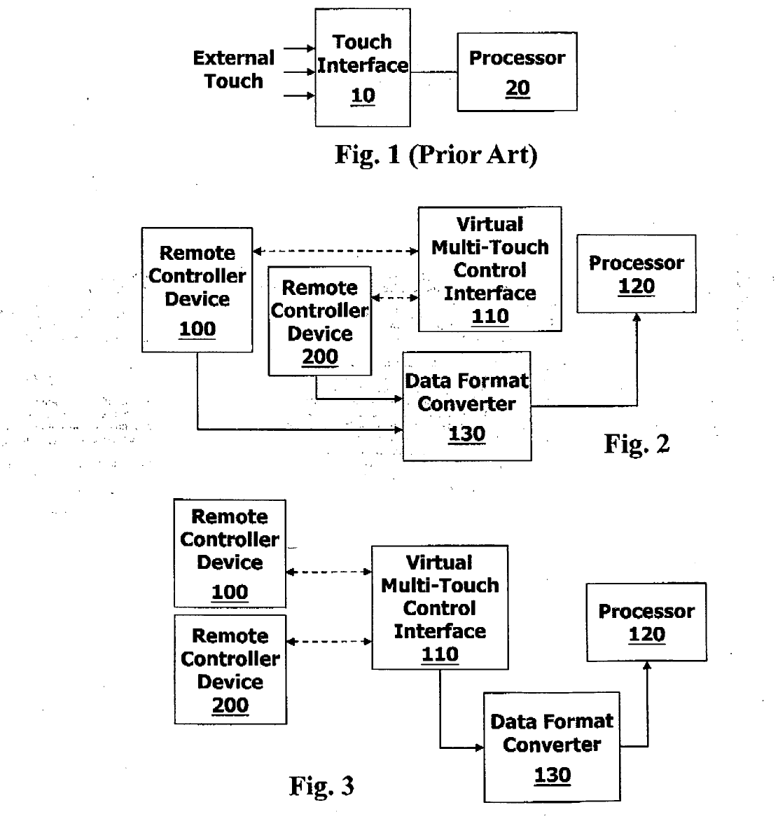

### DESCRIPTION OF THE PREFERRED EMBODIMENTS

The drawings as referred to throughout the description of the present invention are for illustration only, to show the interrelationships between the circuits or structural members, but not drawn according to actual scale.

The virtual multi-touch control apparatus of the present invention can be (but not limited to being) applied to remote control without physical contact, but because one objective of the present invention is to improve the disadvantages of the current physical touch control apparatuses, the term “touch control” is still used in describing the present invention although there may not be physical contact.

Referring to FIGS. 2 and 3, the virtual multi-touch control apparatus of the present invention basically includes one or more devices capable of transmitting multiple remote control signals, such as remote controller devices 100 and 200 (or one single remote controller device transmitting multiple remote control signals, which will be described later), a virtual multi-touch interface 110, a processor 120, and a data format converter device 130. The virtual multi-touch interface 110 generates a graphic display; one or more users interact with the virtual multi-touch interface 110 by the remote controller devices 100 and 200, and the interaction generates coordinates or meaningful action commands (e.g., indicating pressing a location on the graphic display). The user controls the remote controller devices 100 and 200 by, e.g., moving the remote controller devices 100 and 200 or pressing buttons on the remote controller devices 100 and 200. When the user moves the remote controller devices 100 and 200, preferably, indicators are shown and correspondingly move on the graphic display generated by the virtual multi-touch interface 110. The coordinates or action commands generated by the interaction can be converted to electronic signals at the remote controller devices 100 and 200 (FIG. 2), or converted to electronic signals at the virtual multi-touch interface 110 (FIG. 3). The data format converter 130 converts the electronic signals to data with a format that is compatible with the format of the current physical touch control apparatus, and sends the converted data to the processor 120 for data processing. Because the data received by the processor 120 is in proper format, the software in the processor 120 can adopt software currently used in a physical touch control apparatus, which is readily available. In other words, the processor 120 and any circuit following the processor 120 are compatible with the devices used in the current physical touch control apparatus.

The remote controller devices 100 and 200 and the virtual multi-touch interface 110 can be embodied in various forms to meet the requirements of an application. For example, the remote controller devices 100 and 200 can each be a remote controller of a television or a video player, a controller or a pointing device (such as a toy gun) of an electronic entertainment apparatus, an object capable of projecting light (for example but not limited to collimated light) such as a laser pointer, an object capable of receiving light, or a hand-held physical multi-touch screen. The virtual multi-touch interface 110 can be any flat surface, for example can be a television screen or a projector plus a screen, or even a wall.

The remote controller devices 100 and 200 and the virtual multi-touch interface 110 can communicate with each other in wired or wireless manner; it suffices as long as the movement of the remote controller devices 100 and 200 is capable of generating different coordinates. For example, if the remote controller device 100 and 200 are controllers of a video player and the virtual multi-touch interface 110 is a projector plus a screen, a light source can be provided on the projector or the screen, and an image sensor can be provided in each of the remote controller devices 100 and 200, such that the remote controller devices 100 and 200 and the virtual multi-touch interface 110 interact with each other by optical communication. When the remote controller devices 100 and 200 move, the image sensors sense different images, and coordinates and displacements can be generated thereby. (Alternatively, the locations of the light source(s) and the image sensor(s) can be interchanged, i.e., light sources are provided on remote controller devices 100 and 200 and the image sensor is provided in the projector or the screen; or, both the light source(s) and the image sensor(s) can be provided at the same side, and a reflecting material is provided at the other side.) Or, a gyro-sensor or accelerometer can be provided in each of the remote controller devices 100 and 200, and an initial coordinate is given, so that the present coordinate or displacement can be calculated from the initial coordinate and the variations in the sensed gravity or acceleration. The above techniques are presently available and the details thereof are omitted here.

The data format converter 130 can be a stand-alone circuit, or it can be integrated in one or both of the remote controller devices 100 and 200, the virtual multi-touch interface 110, or the processor 120. The data format converter 130 receives a coordinate or action command from the remote controller device 100 or 200 (FIG. 2) or the virtual multi-touch interface 110 (FIG. 3), and converts it to data with a format compatible to the format of the current physical touch control apparatus; the converted data is sent to the processor 120. More specifically, the data format of the current physical touch control apparatus includes four items: (1) two-dimensional coordinate; (2) tip switch (touching or not); (3) in-range information; and (4) pressure. According to the present invention, the coordinate or action command received by the data format converter 130 can be converted in the following manners such that the data is compatible with the format of the current physical touch control apparatus:

### I. Two-Dimensional Coordinate

The current physical touch control apparatus calculates coordinate and displacement according to absolute coordinate system (i.e., every location on a touch interface has an absolute coordinate). If the coordinate received by the data format converter 130 is a relative coordinate (the difference between the present location and a previous location), preferably, the data format converter 130 should convert the relative coordinate to an absolute coordinate. For example, this can be done by giving each of the remote controller devices 100 and 200 an initial coordinate in the initialization stage, such as by aiming the remote controller devices 100 and 200 to a designated location or other methods. In this way, any movement of the remote controller devices 100 and 200 afterward can be converted to an absolute coordinate. In addition, preferably, the data format converter 130 performs scaling conversion on the coordinate (i.e., mapping the coordinate to a larger or smaller scale) and then sends the converted data to the processor 120, wherein the conversion can be done according to the ratio between an area of overall coordinate outputs of the remote controller device 100 or 200 and a size of the graphic display generated by the virtual multi-touch interface 110, such that the coordinate processed by the processor 120 corresponds to the actual coordinate displayed by the virtual multi-touch interface 110.

### II. Tip Switch

According to the present invention, the action command “tip switch” can be achieved in various ways. For example, a button can be provided on each of the remote controller devices 100 and 200, and pressing and releasing the button indicate touching and being away from the virtual multi-touch interface 110. Or, some actions by the remote controller device 100 or 200 (such as fast circular moving in a small rang, or shaking the remote controller device 100 or 200) can be defined as “one touch”. The action command indicating touching and the action command indicating moving can be distinguished from one the other by the acceleration of the remote controller device. If the acceleration is larger than a predetermined threshold, it indicates touching the virtual multi-touch interface 110, and if the acceleration is not larger than the predetermined threshold, it indicates that the user is moving the remote control device but does not intend to touch the virtual touch interface.

As another example, if the remote controller devices 100 and 200 are capable of projecting light (in this case each of the remote controller devices 100 and 200 includes a light source) and the virtual multi-touch interface 110 includes an image sensor, then whether the light source projects light or not (or whether it projects an optical signal of a predefined spectrum or pattern or not) can be defined as “touching” or not: when the light source projects light and sensed by the image sensor, it indicates “touching”, and when the light source is OFF or when the image sensor can not sense the light from the light source, it indicates “not touching”. In this case, because the detection of light indicates “touching”, “touching” and “simply moving but not touching” should be distinguished from one the other. Several examples to distinguish “touching” from “simply moving” are described below:

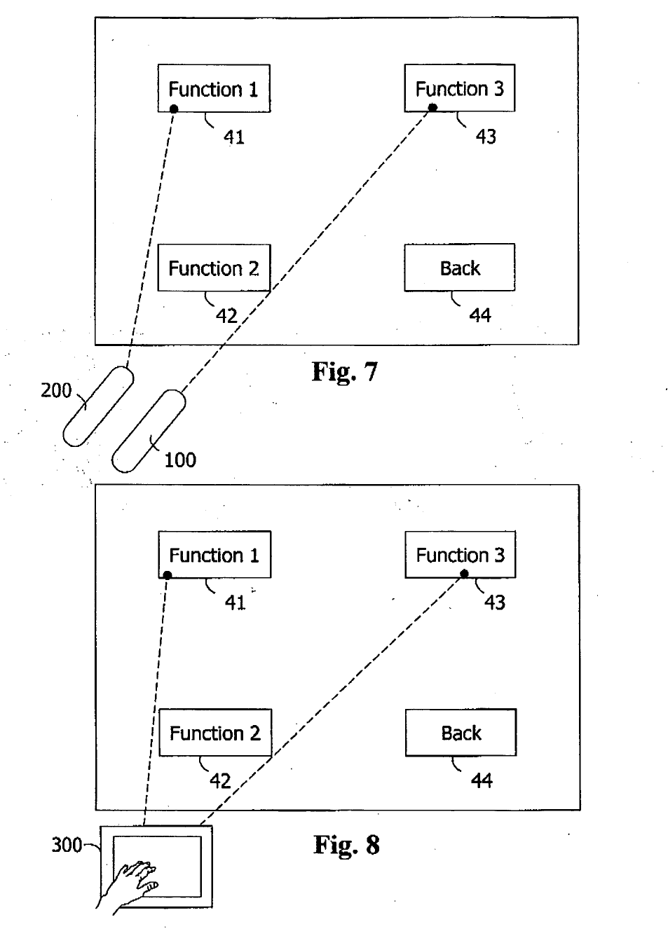

(1) “Touch control region(s)” and “non-touch-control region (s) ” can be provided on the graphic display. Referring to FIG. 7, on the graphic display, the icons 41-44 are touch-controllable, while the area between the icons 41-44 is not touch-controllable. The movement of light in the area between the icons will not trigger the touch control function.

(2) When the image sensor first senses light, it indicates touching; any movement of the light afterward is not touching.

(3) When the light is projected to a location on the graphic display and stays for a time period longer than a predetermined threshold, it indicates touching; if it stays shorter time, it is not touching.

(4) When the image sensor first senses light, it indicates touching; any movement of the light afterward is both touching and moving.

One skilled in this art can readily conceive that in the above arrangements, the ON/OFF of the light source is equivalent to enabling/disabling the image sensor, and as stated above, the locations of the light source and the image sensor are interchangeable. The ON/OFF of the light source (or enablement/disablement of the image sensor) for example can be controlled by a button or by pressure. In the latter case, for example, if the remote controller device 100 or 200 is a pen-shape object, it can be designed in such a way that the light source is turned ON when the user presses the pen-shape remote controller device 100 or 200 on the graphic display.

### III. In-Range

Certain physical touch control apparatuses support detection in the third dimension, to detect whether an object is close to the touch interface and trigger a touch control function accordingly. Certain other physical touch control apparatuses do not support this function, and it is only when there is physical contact that a touch control function is triggered. As to the present invention, because the present invention is already capable of remote touch control, such in-range function is already provided. If required, in the present invention, a button or other means can be provided to turn ON or OFF the detection in the third dimension, so that the remote touch control function is only performed in a predefined range.

### IV. Pressure

According to the present invention, there are various ways to detect “pressure”, i.e., “virtual pressure” in the present invention. For example, if a button is provided on the remote controller device 100 or 200, and pressing and releasing the button indicate touching and being away from the virtual multi-touch interface 110, then it can be arranged in such a way that the time period when the button is pressed indicates the virtual pressure on the virtual touch interface; the longer the time period is, the higher the virtual pressure is. Or, if it is defined that when the remote control device is moved by an acceleration larger than a predetermined threshold, it indicates touching the virtual touch interface, then it can be arranged in such a way that, when the acceleration is larger than the predetermined threshold, the larger the acceleration is, the higher the virtual pressure on the virtual touch interface is. As another example, if the remote controller device 100 or 200 is capable of projecting light, then the time period when the light stays at a certain location can be converted to the virtual pressure, and if it stays longer, the pressure is larger. More specifically, if the stay time is not longer than a predetermined threshold, it indicates not touching the virtual touch interface; if the stay time is longer than the predetermined threshold, it indicates touching, and the stay time is converted to the virtual pressure.

The above explains that the data format converter 130 converts the coordinate or action command it receives to data with a format compatible with the format of the current physical touch control apparatus. Therefore, to implement the present invention, the hardware circuitry including the processor 120 and circuits following the processor 120 and the associate software can adopt existing components of the current physical touch control apparatus. In addition to greatly reducing the development cost, this makes the present invention easier to be put to ready practice. The data format converter 130 can be implemented by hardware, software o firmware.

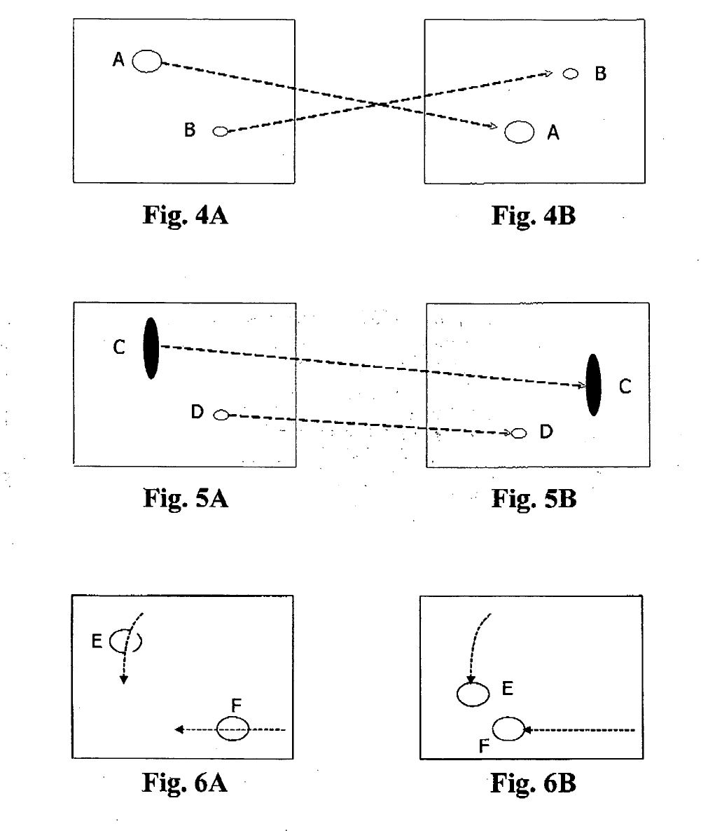

Coordinates generated by different remote controller devices 100 and 200 need to be identified and distinguished from one another such that movements can be correctly identified by correlating coordinates generated by the same remote controller device 100 or 200. To explain this more explicitly, referring to FIGS. 4A and 4B, let us assume that the remote control signal(s) transmitted by the remote controller device 100 generates a coordinate set on the virtual multi-touch interface 110 (the coordinate set may include a single or multiple coordinates, referred to as an “object” hereinafter). This object moves from A in FIG. 4A to A in FIG. 4B (referred to as “object A” hereinafter), and the object generated by the remote control signal(s) transmitted by the remote controller device 200 moves from B in FIG. 4A to B in FIG. 4B (referred to as “object B” hereinafter). A correlation between A-A and a correlation between B-B need to be correctly established. And, another condition which needs to be taken into consideration is that the remote controller devices 100 and 200 may not always be moving; one or both of them may be generating an action command. No matter it is the correlation between coordinate sets at different timings or an action command, such series of remote control signals transmitted by the same remote controller device at different timings is referred to as an “object-tracking series” in the present invention. According to the present invention, objects at different timings can be sorted and grouped into different object-tracking series according to the characteristics or motions of the objects. Each object-tracking series includes a correlation of coordinate sets corresponding to the same object at different timings, or one or more action commands from the same remote controller device.

More specifically, the characteristics may include, for example but not limited to size, shape, color, texture, hollow/solid, aspect ratio of an object. For example, FIGS. 4A and 4B show the object A and object B on the virtual multi-touch interface 110 at an earlier timing and a later timing, respectively. Because the sizes of the object A and the object B are different, correlations can be established between the earlier and later timings according to the characteristics of the sizes of the object A and object B, i.e., an object-tracking series A is generated according to coordinate change (or no change) of the larger object A, and an object-tracking series B is generated according to coordinate change (or no change) of the smaller object B. The processor 120 can correctly identify different object-tracking series and perform correct process steps accordingly. For example, the processor 120 can identify which user has done what action according to an identified object-tracking series. FIGS. 5A and 5B show that object C and object D are different in shape. Thus, an object-tracking series C and an object-tracking series D may be generated according to the characteristic of the shape of the object C and object D. FIGS. 5A and 5B also show that the object C can be distinguished from the object D not only by the characteristic of the shape, but also by the size, color, texture, hollow/solid, and aspect ratio as well.

Besides distinguishing an object from another by the characteristics and establishing different object-tracking series, referring to FIGS. 6A and 6B, the object-tracking series may be established according to the motion of an object. FIGS. 6A and 6B show an object E and an object F on the virtual multi-touch interface 110 at an earlier timing and a later timing, respectively. Because the motions of the object E and the object F are different, an object-tracking series E and an object-tracking series F can be established according to the movement direction, speed, acceleration, or inertia of the above, of the object E and object F; that is, the coordinate sets E in FIG. 6B can be identified to belong to the object E because its movement direction, speed, or acceleration is closer to that of the object E in FIG. 6A, and the same for the object F. The movement direction, speed, or acceleration can be calculated simply by obtaining coordinates of the objects at different timings.

Referring to FIG. 7, the coordinates or action commands generated by interactions between different remote controller devices (such as the remote controller devices 100 and 200) and the virtual multi-touch control interface 110 generate different object-tracking series, i.e., the coordinates or action commands generated by interactions between the remote controller device 100 and the virtual multi-touch control interface 110 are distinguished from the coordinates or action commands generated by interactions between the remote controller device 200 and the virtual multi-touch control interface 110; they will not be confused with each other. Therefore, different remote controller devices can perform different controls, and the purpose of virtual multi-touch control is achieved.

FIG. 8 shows that the multiple remote control signals do not have to be generated from multiple remote controller devices, but instead may be generated from one single remote controller device. For example, referring to FIG. 8, such remote controller device 300 may be a hand-held physical multi-touch control screen. The remote controller device 300 is controllable by a user by multiple touches, to interact with the virtual multi-touch control interface 110 to generate multiple coordinates or action commands, i.e., multiple object-tracking series, to achieve the purpose of virtual multi-touch control.

The task to identify different object-tracking series in correspondence with different objects may be performed in the processor 120, or in an application specific hardware or firmware. In the latter condition, the application specific hardware or firmware may be considered as part of the processor 120. Or, a processor or an application specific hardware or firmware may be provided in the remote controller devices or the virtual multi-touch interface to identify the objects. In such case, the processor or an application specific hardware or firmware may be considered as part of the remote controller devices or the virtual multi-touch interface, and the data received by the data format converter has already contained information regarding objects. Either the processor 120 simply establishes the relationship between identified objects (but does not require to identify the objects because the objects have been identified), or even the relationship between identified objects has been established by the remote controller devices or the virtual multi-touch interface and the processor 120 processes the converted data for other calculations.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. In view of the foregoing, the spirit of the present invention should cover all such and other modifications and variations, which should be interpreted to fall within the scope of the following claims and their equivalents.

What is claimed is:

1. A virtual multi-touch control apparatus, comprising:
a virtual multi-touch control interface for generating a graphic display;
one or more remote controller devices transmitting a plurality of remote control signals, the one or more remote controller devices being controllable by a user to interact with the virtual multi-touch control interface to generate a plurality of coordinates or an action command, wherein each remote control signal generates an object;
a data format converter device converting the coordinates or action command into data with a format compatible to a physical touch control apparatus; and
a processor for processing the converted data,
wherein a plurality of object-tracking series corresponding to different objects are established, each object-tracking series including coordinates or an action command of the same object at different timings.

2. The virtual multi-touch control apparatus as claimed in claim 1, wherein different objects are identified to generate the plurality of object-tracking series according to at least one of the following characteristics: size, shape, color, texture, hollow/solid, and aspect ratio of the objects.

3. The virtual multi-touch control apparatus as claimed in claim 1, wherein different objects are identified to generate the plurality of object-tracking series according to at least one of the following characteristics: movement direction, speed, acceleration, and inertia of the above, of the objects.

4. The virtual multi-touch control apparatus as claimed in claim 1, wherein the interaction between the one or more remote controller devices with the virtual multi-touch control interface generates relative coordinates, and the data format converter device converts the relative coordinates to absolute coordinates.

5. The virtual multi-touch control apparatus as claimed in claim 1, wherein the data format converter device converts the coordinates according to a ratio between an area of overall coordinate outputs of the one or more remote controller devices and a size of the graphic display generated by the virtual multi-touch control interface.

6. A virtue multi-touch control method, comprising:
providing a virtual multi-touch control interface for generating a graphic display;
transmitting a plurality of remote control signals;
generating a plurality of coordinates or an action command by interaction between the plurality of remote control signals and the virtual multi-touch control interface, wherein each remote control signal generates an object;
converting the coordinates or action command into data with a format compatible to a physical touch control apparatus; and
establishing a plurality of object-tracking series corresponding to different objects, wherein each object-tracking series includes coordinates or an action command of the same object at different timings.

7. The virtue multi-touch control method as claimed in claim 6, wherein the step of establishing a plurality of object-tracking series includes: identifying different objects to generate the plurality of object-tracking series according to at least one of following characteristics: size, shape, color, texture, hollow/solid, and aspect ratio of the objects.

8. The virtue multi-touch control method as claimed in claim 6, wherein the step of establishing a plurality of object-tracking series includes: identifying different objects to generate the plurality of object-tracking series according to at least one of the following characteristics: movement direction, speed, acceleration, and inertia of the above, of the objects.
